(19) United States
(12) Patent Application Publication
(10) Pub. No.: US 2014/0274006 A1
(43) Pub. Date: Sep. 18, 2014

(54) SYSTEM AND METHODS FOR AVOIDING CALL FAILURES IN DUAL-SIM DEVICES

(71) Applicant: QUALCOMM INCORPORATED, San Diego, CA (US)

(72) Inventors: Subbarayudu MUTYA, Kukatpally (IN); Jayavarapu Venkata Krishna MURTHY, Hyderabad (IN); Shivank NAYAK, Hyderabad (IN)

(73) Assignee: QUALCOMM INCORPORATED, San Diego, CA (US)

(21) Appl. No.: 13/831,778

(22) Filed: Mar. 15, 2013

(51) Int. Cl. H04W 4/16

(52) U.S. Cl. CPC H04W 4/16
USPC 455/416; 455/558

(57) ABSTRACT

Systems and methods use the capabilities of multiple SIMs to prevent calls from being dropped on a multi-SIM wireless device. In the various embodiments, network conditions may be monitored for signal quality during an active call. When signal quality on the network deteriorates, the multi-SIM wireless device may switch the active call to a network associated with a different SIM that provides better service. To enable the switch, the multi-SIM wireless device may setup a conference call with the called party and the different SIM. In the various embodiments, the multi-SIM wireless devices may be a dual-SIM dual active (DSDA) wireless device.

### FIELD

The present invention relates generally to multi-SIM wireless communication devices, and more particularly to methods of using multi-SIM capabilities to avoid call drops due to poor signal strength.

### BACKGROUND

Cellular telephone communications, such as voice calls, involving at least one wireless device routinely fail because a wireless device enters a location lacking specific network coverage (i.e., a “dead zone”) or high network congestion. Dropping a call, particularly an urgent call, can be frustrating and inconvenient for the parties to the phone call. The failure of a data communication session may be costly and inconvenient to wireless device users. Current wireless devices may enable data transmission over multiple communication pathways, but wireless devices lack a way to leverage simultaneous transmissions across multiple communication pathways to improve data transmission reliability.

Multi-SIM wireless devices have become increasing popular in recent years because of the versatility that they provide, particularly in countries where there are many service providers. For example, dual-SIM smart phones allow a user to implement two different plans or service providers on the same cellular telephone, each with separate telephone numbers and bills (e.g., a business account/number and a personal account/number). Also, during travel, users can obtain local SIM cards and pay local call rates in the destination country. By using multiple SIMs, a user can take advantage of different pricing plans, and save on mobile data usage. Thus, dual-SIM wireless devices effectively provide users with two phones, without the need to carry two separate devices.

While some dual-SIM wireless devices only provide standby dual-SIM capabilities, requiring the user to manually switch between SIMs, other newer dual-SIM wireless devices have dual-SIM dual active (DSDA) capabilities. DSDA wireless devices are able to handle simultaneous active connections with the networks of both SIMs. Typically, DSDA devices have a separate transmit/receive chain (e.g., RF transceiver) for each SIM.

In general mobile communications, if a mobile device (including DSDA devices) with an ongoing call or data session moves to a location covered by a different cell, a handover of the call or data session to the other cell results in order to avoid a poor signal as the device moves out of range of a first cell zone. However, if there are no better cells available for handover, when signal conditions degrade below a minimum sustainable link, the call will be dropped. This call failure may be costly and inconvenient for wireless device user.

Although on a DSDA device a strong radio signal may exist for a network associated with a second SIM, conventional DSDA devices cannot utilize the resources of the second network to continue the call or data session.

### SUMMARY

The various embodiments provide a method for maintaining quality of wireless communications in a multi-SIM wireless device by enabling seamless call transfer between two networks supported by two SIM-based subscriptions without requiring users on either end of the call to take actions. When a first active call is established in a multi-SIM wireless device with a third party device on a first network, and a second SIM of the multi-SIM wireless device is camped on a cell of the second network, the call can be switched from the first network to the second network if necessary to maintain the call (i.e., a cellular connection to the first network is about to be lost). Embodiment methods include establishing a multi-party conference call between the first network corresponding to the first SIM, the second network corresponding to the second SIM, and the third party device in response to determining that the first active call is about to be lost (i.e., leaving cell coverage with no in-network handover available). When the multi-party conference call is established, the method further includes releasing the first active call so the multi-party conference call becomes a new active call between the second network corresponding to the second SIM and the third party device.

In an embodiment, establishing the multi-party conference call may include triggering the second network corresponding to the second SIM to send a paging signal to the first network corresponding to the first SIM, placing the first active call on hold, responding to the paging signal from the second network corresponding to the second SIM, in which a second active call is established between the first SIM and the second SIM, and retrieving the first active call. In an embodiment, determining whether the first active call will be transferred to the second network may include the mobile device monitoring radio channel conditions of a first network connection at the multi-SIM wireless device, determining whether the first network connection has sufficiently deteriorated based on the radio channel conditions of the first network connection, and determining whether there is a handoff cell or network connection within the first network. If the mobile device determines that the connection to the first network is about to be lost and there is no opportunity for an in-network hand off, the mobile device may initiate the embodiment methods for transferring the first active call to the second network when the first network connection has sufficiently deteriorated.

In an embodiment, monitoring radio channel conditions of the first network condition may include monitoring received signal strength for a radio channel of the camped-on cell of the first network, and calculating a received signal strength indicator (RSSI) value for the camped-on cell of the first network. In another embodiment, determining whether the first network connection has sufficiently deteriorated may include comparing the calculated RSSI value for the camped-on cell of the first network to a call failure threshold. In another embodiment, determining whether the first network connection has sufficiently deteriorated may include comparing the calculated RSSI value for the camped-on cell of the first network to a database of low-quality reception zones. In another embodiment, the database of low-quality reception zones may be established based on stored records of past user history, and/or database records of the network.

In another embodiment, triggering the second network corresponding to the second SIM to send the paging signal to the first network corresponding to the first SIM may include starting a timer in response to determining that the calculated RSSI value is below a call failure threshold, and determining whether the timer has expired, in which triggering the second network corresponding to the second SIM is performed upon expiration of the timer. In another embodiment, the method may further include determining whether the timer is running and cancelling the timer in response to determining that the calculated RSSI value for the cell of the first network is not below a trigger threshold. In another embodiment, the duration of the timer may be preset through user input received by the multi-SIM wireless device. In another embodiment, the call failure threshold may be determined based upon user inputs received by the multi-SIM wireless device. In another embodiment, determining whether the first network connection has sufficiently deteriorated may further include monitoring received signal strength for the camped-on cell of the second network, calculating a RSSI value for a radio channel of the camped-on cell of the second network, and comparing the calculated RSSI values for the camped-on cells of the first and second networks.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a wireless communication system suitable for use with the various embodiments.

FIGS. 2A and 2B are block diagrams illustrating a dual-SIM wireless communication device according to an embodiment.

FIGS. 3A and 3B are process flow diagrams illustrating embodiment methods for determining whether a call with a third party device should be transferred from a first network to a second network.

FIG. 4 is a process flow diagram illustrating an embodiment method for transferring a call with a third party from a first to a second network.

FIG. 5 is a message flow diagram of communications management (CM) sub-layers for protocol stacks associated with the first and second subscriptions, and components of a first and second network, for managing an active call, and transferring the active call to a different network.

FIG. 6 is a component diagram of another example mobile device suitable for use with the various embodiments.

FIG. 7 is a component diagram of another example mobile device suitable for use with the various embodiments.

FIG. 8 is a component diagram of an example server suitable for use with the various embodiments

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “wireless device” and “wireless communication device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “SIM”, “SIM card” and “subscriber identification module” are used interchangeably to mean an integrated circuit, embedded into a removable card, that stores an International Mobile Subscriber Identity (IMSI), related key, and/or other information used to identify and/or authenticate a wireless device on a network. The term SIM may also be used as shorthand reference to a communication network associated with a particular SIM, since the information stored in a SIM enables the wireless device to establish a communication link with a particular network, thus the SIM and the communication network correlate to one another.

As used herein, the terms “multi-SIM device,” “multi-SIM wireless device” “dual-SIM device” “dual-SIM dual active device” and “DSDA device” are used interchangeably to describe a wireless device that is configured with more than one SIM and is capable of independently handling communications with networks of both subscriptions.

The various embodiments use the simultaneous communication capabilities of a multi-SIM device to improve the quality of an active call or data session. In the various embodiments, a multi-SIM device may switch an active call between networks associated with different SIMs to avoid dropping active calls when network conditions deteriorate.

In an embodiment, a dual-SIM dual-active (DSDA) device may detect poor signal quality of a first network based on present signal strength conditions or link quality. For example, the DSDA device may periodically measure a Received Signal Strength Indicator (RSSI) value on one or both networks. In a further embodiment, the DSDA device may utilize a procedure for predicting that it is about to enter a poor quality cell zone. This prediction of entering a low-quality cell zone may be based on the location, orientation, and velocity of the wireless device, which may be compared to a database of low-quality reception zones. The location of wireless dead zones may be established based on stored records of past user history, and/or database records of the network.

If signal or link conditions of the first network deteriorate, or the first network predicts that a poor quality signal area will be entered, a DSDA device may attempt to perform a hand-off of the active communication to another nearby tower (e.g., a tower closer to the present location of the DSDA). However, if no such hand-off is possible (i.e., the DSDA is not receiving a sufficient signal from any nearby tower), the communication may be dropped under normal circumstances, even if a network associated with the second SIM would provide a strong signal for the communication. The various embodiments describe a method of transferring an active communication in a dual-SIM device from a first network associated with a first SIM to a second network associated with the second SIM, such that the communication may continue instead of being dropped due to poor signal conditions of the first network.

In the various embodiments, upon deterioration of network conditions, a multi-SIM device may activate a conference call to the called party over both the original network and a second network associated with an idle SIM. The multi-SIM device may transfer the call to the second network and release the call through the original network, thereby preventing a call drop. The various embodiments therefore may provide efficient use of the multi-SIM wireless device's resources to achieve an optimal user experience. The various embodiments may also provide utility in a variety of situations, for example, to avoid call drops of emergency calls.

In the various embodiments, each SIM may enable communications over its network using different transmit/receive chains of a DSDA device, and/or different wireless communication protocols. In the various embodiments, a multi-SIM wireless device may be a dual-SIM dual active (DSDA) device in which each SIM is associated with an independent radio transmit/receive chain (e.g., independent RF transceivers).

The methods of the various embodiments may be utilized under weak signal conditions on the networks associated with either SIM. While the terms “first” and “second” are used herein described the SIMs and associated networks for the call switching procedures in the various embodiments, such identifiers are merely for convenience and are not meant to limit the various embodiments to a particular order, sequence, type of network or carrier.

In the various embodiments, audio capture may include receiving audio inputs via a microphone of the wireless device and preparing the audio inputs for transmission, as well as converting received data to audio outputs via a speaker of the wireless device. In the various embodiments, calls may include continuous streams of audio data exchanged between wireless devices and/or servers. While example embodiments are discussed in terms of operations performed to transmit and receive streams of data during audio calls (i.e., voice calls), the various embodiment methods may also be implemented to transmit and receive video calls (i.e., audio and video calls or video only calls). While example embodiments are discussed in terms of operations to switch a call between networks associated with two SIMs, additional SIMs and network connections may be enabled in a multi-SIM wireless device.

FIG. 1 illustrates a wireless network system 100 suitable for use with the various embodiments. Wireless devices 102, 104 may be configured to establish wireless connections with cell towers or base stations of one or more radio access networks. For example, wireless devices 102, 104 may transmit/receive data using base stations 106, 108, which may be part of a network 110, as is known in the art. Wireless device 102 may further be configured to transmit/receive data through base station 112, which may be part of a different network 114.

The wireless networks 110, 114 may be cellular data networks, and may use channel access methods including, but not limited to, Frequency Division Multiple Access (FDMA), Time Division Multiple Access (TDMA), Code Division Multiple Access (CDMA), Universal Mobile Telecommunications Systems (UMTS) (particularly, Long Term Evolution (LTE)), Global System for Mobile Communications (GSM), Wi-Fi, PCS, G-3, G-4, or other protocols that may be used in a wireless communications network or a data communications network. Networks 110, 114 may use the same or different wireless interfaces and/or physical layers. In an embodiment, base stations 106, 108, 112 may be controlled by one or more base station controllers (BSC) 116, 118. For example, base stations 106, 108, BSC 116, and other components may form network 110, as is known in the art. Alternate network configurations may also be used and the embodiments are not limited to the configuration illustrated. For example, in another embodiment the functionality of the BSC 116 and at least one of base stations 106, 108 may be collapsed into a single “hybrid” module having the functionality of these components.

In the various embodiments, a wireless device 102 may simultaneously access core networks 120, 122 after camping on cells managed by base stations 106, 112. Wireless device 102 may also establish connections with Wi-Fi access points, which may connect to the Internet. While the various embodiments are particularly useful with wireless networks, the embodiments are not limited to wireless networks and may also be implemented over wired networks with no changes to the methods.

In wireless network system 100, wireless device 102 may be a multi-SIM device that is capable of operating on a plurality of SIMs. For example, the wireless device 102 may be a dual-SIM device. Using dual-SIM functionality, the wireless device 102 may simultaneously access two core networks 120, 122 by camping on cells managed by base stations 106, 112. Core networks 120, 122 may be interconnected by public switched telephone network (PSTN) 124, across which the core networks 120, 122 may route various incoming and outgoing communications to the wireless device 102.

The wireless device 102 may make a voice or data call to a third party device, such as wireless device 104, using one of the SIMs. The wireless device 102 may also receive a voice call or other data transmission from a third party. The third party device (e.g., wireless device 104) may be any of a variety of devices, including, but not limited to, a mobile phone, laptop computer, PDA, server, etc.).

A SIM in the various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM).

Each SIM card may have a CPU, ROM, RAM, EEPROM and I/O circuits. The SIM cards used in the various embodiments may contain user account information, an international mobile subscriber identity (IMSI), a set of SIM application toolkit (SAT) commands and storage space for phone book contacts. A micro-processing unit (MCU) of a baseband chip may interact with MCUs of SIM cards to retrieve data or SAT commands from the SIM cards installed in a wireless device. A wireless device may be immediately programmed after plugging in the SIM card. SIM cards may be also programmed to display custom menus for personalized services. A SIM card may further store a Home Public-Land-Mobile-Network (HPLMN) code to indicate the SIM card network operator provider. An Integrated Circuit Card Identity (ICCID) SIM serial number is printed on the SIM card for identification.

FIG. 2A is a functional block diagram of a multi-SIM wireless device 102 that is suitable for implementing the various embodiments. Wireless device 200 may include at least one controller, such as general processor 202, which may be coupled to at least one memory 204. Memory 204 may store, for example, an operating system (OS) and user application software. Wireless device 200 may also include a baseband processor 206 to perform baseband/modem functions. Baseband processor 206 may be a single device that performs baseband/modem functions for all SIMs, or may be multiple independent baseband processors (e.g., BB1, BB2), each of which performs functions for one of the SIMs of wireless device 200. At least two SIMs 208a, 208b may be connected logically with the at least one baseband processor 206 through SIM interfaces 210a, 210b.

Wireless device 200 may also include a RF transceiver 212 that is connected logically with the baseband processor 206, and with at least one antenna 214. RF transceiver 212 may be a single device that performs transmit/receive functions for all SIMs, or may be multiple independent RF transceivers (e.g., RF1, RF2), each of which performs transmit/receive functions for one SIM of wireless device 200.

In a particular embodiment, the general processor 202 memory 204, and baseband processor 206 may be included in a system-on-chip device 216. The first and second SIMs 208a, 208b and their corresponding interfaces 210a, 210b may be external to the system-on-chip device 216. Further, various input and output devices may be coupled to components of the system-on-chip device 216, such as interfaces or controllers.

Example user input components suitable for use in the wireless device 200 may include, but are not limited to, keypad 222, touchscreen display 224, microphone 226, etc., shown in FIG. 2B. In an embodiment, the keypad 222, touchscreen display 224, microphone 226, or a combination thereof, may perform the function of receiving the request to initiate an outgoing call. For example, the touchscreen display 224 may receive a selection of a contact from a contact list or receive a telephone number. In another example, either or both of the touchscreen display 224 and microphone 226 may perform the function of receiving a request to initiate an outgoing call. For example, the touchscreen display 224 may receive selection of a contact from a contact list or to receive a telephone number. As another example, the request to initiate the outgoing call may be in the form of a voice command received via the microphone 226. Interfaces may be provided between the various software modules and functions in wireless device 200 to enable communication between them, as is known in the art.

Referring to FIG. 2B, wireless device 200 may have a layered software architecture 250 to communicate over access networks associated with SIMs. The software architecture 250 may be distributed among one or more processors, such as baseband processor 206. In the various embodiments, the software architecture 250 for a multi-SIM device may have multiple protocol stacks, each of which may be associated with a different SIM. For example, wireless device 200 may be configured with protocol stacks 252a, 252b, associated with SIMs 208a, 208b. Protocol stacks 252a, 252b may support any of variety of standards and protocols for wireless communications.

The bottom layers of the protocol stacks 252a, 252b may be physical layers 254a, 254b that establish connections over the air interface and manage network resources for the wireless device 200. Residing above physical layers 254a, 254b may be data link layers 256a, 256b, which may provide functions to handle incoming and output data across a physical link in the network. For example, data link layers 256a, 256b may divide output data into data frames, and analyze incoming data to ensure it has been successfully received. In an embodiment, each data link layer 256a, 256b may contain various sub-layers (e.g., media access control (MAC) and logical link control (LLC) layers).

Network layers 258a, 258b may reside above data link layers 256a, 256b, which may perform functions including allocating radio channels and establishing links between the wireless device 200 and a network. In an embodiment, each network layer 256a, 256b may be partitioned into one or more sub-layers (not shown). In an embodiment, a sub-layer of a network layer 256a, 256b may be a connection management (CM) sub-layer to route calls, select a service type, prioritize data, perform QoS functions, etc.

While protocol stacks 252a, 252b provide functions to transmit data through physical media, the software architecture 250 may further include at least one host layer 262 to provide data transfer services to various applications in wireless device 200. In an embodiment, application-specific functions provided by the at least one host layer 262 may provide an interface between protocol stacks 252a, 252b and general processor 202. In an alternative embodiment, the protocol stacks 252a, 252b may each include one or more higher logical layers (e.g., transport, session, presentation, application, etc.) that provide host layer functions. In an embodiment, software architecture 250 may further include a hardware interface 264 between physical layers 254a, 254b and the communication hardware (e.g., one or more RF transceivers).

In the various embodiments, a multi-SIM device such as wireless device 200 may determine whether, based on network conditions of an ongoing call or data session, the call or data session should be transferred to a different network associated with a different SIM. In the various embodiments, this determination may be a determination of whether a trigger event has occurred.

In an embodiment, a trigger event may be a detection of poor or degrading signal quality in a communication link. The trigger event may occur or be recognized as a result of multiple steps, including assessing the signal strength of the network connection that is presently active for the ongoing communication. For example, a processor of the wireless device may monitor signal conditions of a network and determine whether the call quality has fallen below a threshold value. In the various embodiments, “signal strength”, “network signal strength”, and “radio channel conditions” may all refer to measurements that indicate the relative strength of a signal in the radio channel over which a communication is established. In the various embodiments, measurements of signal strength may include received radio signal strength indicator (RSSI) values, carrier-to-noise ratio values, etc.

In an embodiment, a wireless device may monitor present received signal strength indicator (RSSI) values for the network on which a call or data session is active, and may compare these values to a predetermined threshold value (i.e., a call failure threshold). In an embodiment, RSSI values may be sampled by an internal audio-digital converter and the results may be available to a processor of the wireless device. In an alternative embodiment, a trigger event may be a prediction that the wireless device may soon enter or is approaching a limited cellular coverage area or low call quality zone (i.e., dead zone). As an example, a wireless device may be configured with various sensors, such as GPS sensors and accelerometers, to determine a likely path of travel for the wireless device. In an embodiment, a processor of the wireless device may compare the likely path of travel to a cellular coverage map to predict whether the wireless device will enter or is approaching a limited cellular coverage area, or dead zone, and the prediction that the wireless device is approaching a limited cellular coverage area, or dead zone may be a trigger event. In a similar embodiment, a user of the wireless device may have previously designated a specific area as a poor quality area. A prediction based on the likely path of travel that the wireless device is approaching the poor signal strength area may be a trigger event.

FIG. 3A illustrates an embodiment method 300 for evaluating the need to transfer an active communication from a first network to a second network. The operations of method 300 may be implemented by one or more processors of a dual-SIM device, such as a baseband processor 206 in the wireless device 200 described above with reference to FIG. 2. In block 302, a wireless device may register on a first network using a first SIM, and on a second network using a second SIM. This may be performed using registration parameters included on the SIMs at start-up, which may vary depending on the particular carrier. In block 304, an active wireless communication may be established between the wireless device and a third-party device over the first network. For example, a mobile-originating (MO) call may be initiated by a wireless device user dialing a third-party telephone number. In another example, the wireless device may receive a mobile-terminating (MT) call from a third-party device dialing the MSISDN associated with the first SIM. The wireless device may transmit/receive a continuous stream of audio data over the first network to/from the third-party device (e.g., a phone conversation).

In block 306, the wireless device may receive or monitor present network conditions of the first network, such as radio channel conditions. In an embodiment, present radio channel conditions may include the current received signal strength indicator (RSSI) values sampled by an internal audio-digital converter. In determination block 308, the wireless device may determine whether a radio channel failure condition for the first network is met. In an embodiment, a radio channel failure condition may be, for example, a current RSSI and/or carrier-to-noise ratio that is below a predetermined threshold value (e.g., RSSI<−100 db).

If the wireless device determines that the radio channel failure condition is not met (i.e., determination block 308=“No”), the wireless device may continue to transmit/receive the established voice call or data session on the first network, block 310. If the radio channel failure condition is met (i.e., determination block 308=“Yes”), the wireless device may determine whether the active call or data session can be continued using a different cell channel, determination block 312. For example, if the wireless device has moved locations during the ongoing communication, it may be within the range of one or more neighboring cells of the first network. If the wireless device determines that a different cell channel is available to continue the communication (i.e., determination block 312=“Yes”), the wireless device may send a signal to the network to cause a handover to the base station associated with that cell to be performed, and may continue with the active call or data session on the first network, block 310. If the wireless device determines that no other cell is available (i.e., determination block 312=“No”), the wireless device may determine whether a second SIM in the device, associated with a second network, is idle, determination block 314.

If the wireless device determines that the second SIM is not idle (i.e., determination block 314=“No”), the wireless device may continue to transmit/receive the established voice call or data session on the first network, block 310. If the wireless device determines that the second SIM is idle (i.e., determination block 314=“Yes”), indicating that the transmit/receive chain associated with the second SIM is not actively engaged in a voice or data call, the wireless device may test the signal conditions of the second network (e.g., radio channel conditions) in block 316. For example, the wireless device may prompt an audio-digital converter to measure RSSI values of a test connection with the second network, which values may be made available to the wireless device. In determination block 318, the wireless device may determine whether the current radio channel conditions for the second network are favorable. For example, the wireless device may determine whether a radio channel failure condition is met for the second network connection, in the same manner as the determination for radio channel conditions on the first network discussed above. A radio channel failure condition may be, for example, present RSSI values falling below a threshold (e.g., RSSI<−100 db.). The determination of whether the radio channel conditions for the second network connection are favorable may be performed by determining whether a radio channel failure condition is met, similar to the determination for the first network discussed above with respect to determination block 308. Alternatively, the current radio channel conditions for the second network may be compared to those of the first network, and may be favorable if better than the first network. If the wireless device determines that the radio channel conditions for the second network are not favorable (i.e., determination block 316=“No”) the wireless device may continue the active call or data session over the first network. If the wireless device determines that the radio channel conditions for the second network are favorable (i.e., determination block 316=“No”), the wireless device may proceed to transfer the active call or data session to the second network, described below with respect to FIG. 4.

In a further embodiment, present radio channel conditions that are below a call failure threshold may trigger the use of a timer to affect an appropriate response.

FIG. 3B shows an alternative embodiment method 350 for determining whether to transfer the active call or data session to a second network. Method 350 is similar to method 300 of FIG. 3A, with the addition of a timer to trigger the transfer steps to a second network. In method 350, the wireless device may determine whether a trigger threshold is met in determination block 352. The trigger threshold may be, for example, a particular RSSI value, and may be the same as or different from the radio channel failure condition in determination block 308 of FIG. 3A. If the wireless device determines that the trigger threshold is met (i.e., determination block 352=“Yes”), the wireless device may start a transfer timer in block 354. The wireless device determines that may proceed to determination blocks 308 through 316 in the same manner as described above with respect to FIG. 3A. If the wireless device determines that the wireless device determines that the present radio channel conditions for the second network are favorable (i.e., determination block 318=“Yes”), the wireless device may proceed in a loop to determine whether the transfer timer has expired in determination block 354. If the wireless device determines that the transfer timer has not expired, the wireless device may continue in the loop of determination block 354. If the wireless device determines that the transfer timer has expired (i.e., determination block 356=“Yes”), the wireless device may proceed to transfer the active call or data session from the first network to the second network.

In the various embodiments, the wireless device may have one or more user-configurable options. For example, the wireless device may be configured to receive a user input to disable call transfer between SIMs. In an embodiment, the wireless device may allow the user to disable the call transfer between SIMs for calls that match (or do not match) a set of criteria established by the user. In another embodiment, the wireless device may allow the user to select to activate or disable the call transfer procedure on a per-call basis to override a default setting. For example, when the user has disabled call transfer between SIMs as a default setting, the wireless device may allow the user to activate call transfer for a particular call. Similarly, when call transfer is enabled as the default setting, the user may cancel the call transfer procedure for a particular call. In an embodiment, prior to performing a default action (e.g., either initiating or skipping call transfer to a different SIM), the wireless device may alert the user that the active call should transferred. Such an alert may include, for example, a visual or audio notification that is output through a user interface, and the user interface may receive the user's inputs to enable or disable call transfer. Additionally or alternatively, such an alert may include an in-band audio tone in the active call.

FIG. 4 illustrates an embodiment method 400 for transferring an active communication on a first network and SIM to a second network and SIM. As a result of the steps in FIG. 3A or 3B, the wireless device may determine that an ongoing call with a third-party device should be transferred to a second network. As discussed above, a baseband processor, or multiple baseband processors, may execute modem software including a protocol stack for each SIM. As will be understood by those of ordinary skill in the art, the terms “first SIM stack processor” and “second SIM stack processor” are merely functional in order to show a relationship with a respective SIM, and are not intended to limit these elements to any particular hardware or software implementation.

In block 402, a first SIM stack processor may send an internal signal to a second SIM stack processor, causing the second SIM stack processor to send a paging signal for a voice call to the MSISDN associated with the first SIM (“MSISDN1”). As will be understood by one of ordinary skill in the art, the designations of SIM stack processors as first and second are based only on function, and are not intended to limit these elements to any particular hardware or software implementation.

In block 404, the first SIM stack processor may receive the paging signal for a MT call from the MSISDN associated with the second SIM (“MSISDN2”). In block 406, the wireless device may place the call with the third party device on hold. In block 408, the first SIM stack processor may accept the incoming call from the second SIM (e.g., by sending a setup message to the second SIM stack processor to establish the call with MSISDN2). In block 410, the first SIM stack processor may retrieve the call with the third party device from which a conference call may be established between wireless device via the first network corresponding to the first SIM, the third party device (on the first network) and the wireless device via the second network corresponding to the second SIM (on the second network) in block 412. In block 414, the wireless device may send a call transfer command to transfer the active call with the third party device to the second network, thereby releasing the connection to the third party device through the first network. In block 416, the wireless device may continue the active call with the third party device through the second SIM on the second network.

In an embodiment, the call transfer process may be performed using the Explicit Call Transfer (ECT) function, which is a call transfer supplementary service described in the 3GPP TS 24.091 standards specification. Therefore, following the CALL_TRANSFER, a direct communication exists between the device and Party B over the second SIM on the second network. Since the method uses existing functionality defined in the 3GPP TS 24.091 standards specification, no changes to carrier networks or communication standards are required, and the invention may be implemented in the software configuration of the wireless device.

FIG. 5 is a message flow diagram of example messages that may be exchanged during an active call on a dual-SIM wireless device, such as wireless device 200. In an embodiment, a connection management sub-layer (e.g., CM1, CM2) of the network layer in each protocol stack may operate to manage supplementary services. For example, CM1 may transmit a call setup message 502 to a component of the first network (e.g., network 110) to establish a voice call or data session (“Call A”) with a third party device. The network component may be, for example, a base station 106, 108, a BSC 116, and/or any of a variety of other devices that may directly or indirectly perform call setup functions for a SIM of wireless device 200. As discussed above, the wireless device may contain hardware that monitors network conditions, for example, radio signal strength. The physical layer (PL1) of the protocol stack may send a message 504 to CM1 alerting CM1 to changes in present radio signal strength on the first network 110 (e.g., RSSI events), and may provide information enabling CM1 to calculate a present RSSI value. If radio channel conditions meet a call failure threshold, a Call_Trigger_Handler( ) routine may be initiated by CM1 to determine whether to transfer the call to the second network. In an embodiment, Call_Trigger_Handler( ) may be called to provide functions discussed above with respect to FIGS. 3A and 3B, such as evaluating signal strength of a network to perform an appropriate response. For example, Call_Trigger_Handler( ) may evaluate RSSI values for incoming signal strength of the network of the active call (i.e., first network 110). In an embodiment, the RSSI values may be compared against a call failure threshold for the first network 110.

In the various embodiments, if a call failure condition is met (e.g., present RSSI value is below a trigger threshold), a Call_Trigger_Timer( ) handler may start a transfer timer, as discussed above with respect to FIG. 3B. Upon expiration of the timer, CM1 may determine that Call A will be transferred to the second network. In an embodiment, if, after the transfer timer starts, the present RSSI value returns to a level that is above the call failure threshold, the threshold timer may be cancelled. In the various embodiments, the call failure threshold and/or transfer timer duration may be set by a user.

If Call A is to be transferred to the second network, CM1 may send message 506 to CM2. Message 506 may contain parameters such as MSISDN1 to provide instruction to CM2. In response to receiving message 506, CM2 may send call setup request to a component of a second network 114 (e.g., base station 112, BSC 118, etc.) in message 508, requesting setup of a MO call to MSISDN1. As a result, a paging signal message 510 for a MT voice call from CM2 may be transmitted by the first network 110 to CM1.

CM1 may place Call A on hold by sending message 512 to the first network 110, and may also send a page response message 514 to the first network 110. The first network may send a call setup message 516 to CM1 to establish a voice call between CM1 and CM2 (“Call B”). CM1 may send a message 518 to retrieve the on-hold Call A. In this manner, a multi-party conference call may be established between CM1, CM2, which may include a series of messages 520, 522.

To transfer the Call A from the first network 110 to the second network 114, a Call_Release_Handler( ) routine may be initiated by CM1. CM1 may send a message 524 to the first network 110, requesting release of Call A. The first network 110 may send a message 526 to CM1 acknowledging that Call A has been released. The voice call that was formerly the multi-party conference call may remain active between CM2 and the third party device on the second network 114, which may include a series of messages 528, 530.

The various embodiments may be implemented in any of a variety of wireless devices, an example of which is illustrated in FIG. 6. For example, the wireless device 600 may include a processor 602 coupled to internal memories 604 and 610. Internal memories 604 and 610 may be volatile or non-volatile memories, and may also be secure and/or encrypted memories, or unsecure and/or unencrypted memories, or any combination thereof. The processor 602 may also be coupled to a touch screen display 606, such as a resistive-sensing touch screen, capacitive-sensing touch screen infrared sensing touch screen, or the like. Additionally, the display of the wireless device 600 need not have touch screen capability. Additionally, the wireless device 600 may have one or more antenna 608 for sending and receiving electromagnetic radiation that may be connected to one or more a wireless data link and/or cellular telephone transceiver 616 coupled to the processor 602. The wireless device 600 may also include physical buttons 612a and 612b for receiving user inputs. The wireless device 600 may also include a power button 618 for turning the wireless device 600 on and off. The wireless device 600 may also include a battery 620 coupled to the processor 602. The wireless device 600 may also include a position sensor 622, such as a GPS receiver, coupled to the processor 602.

The various embodiments described above may also be implemented within a variety of personal computing devices, such as a laptop computer 710 as illustrated in FIG. 7. Many laptop computers include a touch pad touch surface 717 that serves as the computer's pointing device, and thus may receive drag, scroll, and flick gestures similar to those implemented on mobile computing devices equipped with a touch screen display and described above. A laptop computer 710 will typically include a processor 711 coupled to volatile memory 712 and a large capacity nonvolatile memory, such as a disk drive 713 of Flash memory. The laptop computer 710 may also include a floppy disc drive 714 and a compact disc (CD) drive 715 coupled to the processor 711. The laptop computer 710 may also include a number of connector ports coupled to the processor 711 for establishing data connections or receiving external memory devices, such as a USB or FireWire® connector sockets, or other network connection circuits for coupling the processor 711 to a network.

In a notebook configuration, the computer housing includes the touchpad 717, the keyboard 718, and the display 719 all coupled to the processor 711. The laptop computer 710 may also include a battery 720 coupled to the processor 711. The laptop computer 710 may also include a position sensor 722, such as a GPS receiver, coupled to the processor 711. Additionally, the laptop computer 710 may have one or more antenna 708 for sending and receiving electromagnetic radiation that may be connected to one or more a wireless data link and/or cellular telephone transceiver 716 coupled to the processor 711. Other configurations of the computing device may include a computer mouse or trackball coupled to the processor (e.g., via a USB input) as are well known, which may also be used in conjunction with the various embodiments.

The various embodiments may also be implemented on any of a variety of commercially available server devices, such as the server 800 illustrated in FIG. 8. Such a server 800 typically includes a processor 801 coupled to volatile memory 802 and a large capacity nonvolatile memory, such as a disk drive 803. The server 800 may also include a floppy disc drive, compact disc (CD) or DVD disc drive 804 coupled to the processor 801. The server 800 may also include network access ports 806 coupled to the processor 801 for establishing network interface connections with a network 807, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors 602, 711, and 801 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 604, 610, 712, 713, 802, and 803 before they are accessed and loaded into the processors 602, 711, and 801. The processors 602, 711, and 801 may include internal memory sufficient to store the application software instructions. In many devices the internal memory may be a volatile or nonvolatile memory, such as flash memory, or a mixture of both. For the purposes of this description, a general reference to memory refers to memory accessible by the processors 602, 711, and 801 including internal memory or removable memory plugged into the device and memory within the processor 602, 711, and 801 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory processor-readable storage medium. The steps of a method or algorithm disclosed herein may be embodied in a processor-executable software module which may reside on a non-transitory computer-readable storage medium. Tangible, non-transitory processor-readable storage media may be any available media that may be accessed by a processor of a computer, mobile computing device or a wireless communication device. By way of example, and not limitation, such non-transitory processor-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a processor of a computing device. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory processor-readable media. Additionally, the operations of a method or algorithm may reside as one or any combination or set of codes and/or instructions on a tangible, non-transitory machine readable medium and/or non-transitory processor-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for maintaining quality of wireless communications on a multi-SIM wireless device including at least a first SIM and a second SIM, comprising:
establishing a first active call with a third party device on a first network associated with the first SIM;
determining whether the first active call should be transferred to a second network associated with the second SIM;
establishing, via the first network associated with the first SIM, a multi-party conference call between the multi-SIM wireless device, the second network associated with the second SIM, and the third party device in response to determining that the first active call should be transferred to the second network; and
releasing the first active call so that the multi-party conference call becomes a new active call between the multi-SIM wireless device and the third party device via the second network associated with the second SIM.

2. The method of claim 1, wherein establishing the multi-party conference call comprises:
triggering the second network associated with the second SIM to send a paging signal to the first SIM;
placing the first active call on hold;
responding to the paging signal from the second network associated with the second SIM, thereby establishing a second active call; and
removing the first active call from hold.

3. The method of claim 2, wherein determining whether the first active call should be transferred to the second network comprises:
monitoring radio channel conditions of a first network connection in the multi-SIM wireless device; and
determining whether the first network connection has sufficiently deteriorated based on the radio channel conditions of the first network connection.

4. The method of claim 3, wherein monitoring radio channel conditions of the first network connection comprises:
monitoring received signal strength for a radio channel of a camped-on cell of the first network; and
calculating a received signal strength indicator (RSSI) value for the camped-on cell of the first network.

5. The method of claim 4, wherein determining whether the first network connection has sufficiently deteriorated comprises comparing the calculated RSSI value for the camped-on cell of the first network to a call failure threshold.

6. The method of claim 5, further comprising:
determining whether the calculated RSSI value for the cell of the first network is below the call failure threshold.

7. The method of claim 6, wherein triggering the second network associated with the second SIM to send the paging signal to the first SIM comprises:
starting a timer in response to determining that the calculated RSSI value is below a trigger threshold; and
determining whether the timer has expired, wherein the triggering the second network associated with the second SIM to send the paging signal is performed upon expiration of the timer.

8. The method of claim 7, further comprising:
determining whether the timer is running and cancelling the timer in response to determining that the calculated RSSI value for the cell of the first network is not below the trigger threshold.

9. The method of claim 8, wherein the trigger threshold is equal to the call failure threshold.

10. The method of claim 8, wherein the trigger threshold is independent of the call failure threshold.

11. The method of claim 7, wherein a duration of the timer is preset in response to a user input received by the multi-SIM wireless device.

12. The method of claim 5, wherein the call failure threshold is determined based upon user input received by the multi-SIM wireless device.

13. The method of claim 5, wherein determining whether the first network connection has sufficiently deteriorated further comprises:
monitoring received signal strength for a camped-on cell of the second network;
calculating a RSSI value for a radio channel of the camped-on cell of the second network; and
comparing the calculated RSSI values for the camped-on cells of the first and second networks.

14. The method of claim 13, wherein determining whether the first active call will be transferred to the second network further comprises determining whether the second SIM is idle.

15. The method of claim 1, wherein determining whether the first active call will be transferred to the second network comprises:
determining whether a sufficient signal is received by the multi-SIM wireless device from one or more neighboring cells in the first network,
wherein the first active call is maintained on the first network and handed off to a neighboring cell in response to determining that a sufficient signal is received by the multi-SIM wireless device from one or more neighboring cells in the first network.

16. The method of claim 3, wherein monitoring radio channel conditions of the first network connection comprises
monitoring a carrier-to-noise ratio of a received radio signal of the first network.

17. The method of claim 1, wherein releasing the first active call comprises:
sending a message containing an Explicit Call Transfer (ECT) supplementary services request to a component of the first network.

18. The method of claim 1, wherein the multi-SIM wireless device is a dual-SIM dual active (DSDA) wireless communication device.

19. The method of claim 1, wherein a channel access method implemented by the first network is different than a channel access method implemented by the second network.

20. The method of claim 1, further comprising:
presenting, through a user interface, a selectable option to disable call transfers between the first SIM and the second SIM,
wherein determining whether the first active call will be transferred to the second network comprises:
determining whether user input to disable call transfers between the first SIM and the second SIM has been received, wherein the first active call is maintained on the first network in response to determining that the call transfer option has been disabled.

21. The method of claim 20, wherein presenting, through the user interface, the selectable option to disable call transfers between the first SIM and the second SIM includes presenting a selectable option to disable call transfers for calls that satisfy a set of criteria.

22. The method of claim 1, further comprising:
determining a present location of the multi-SIM wireless device; and
predicting whether a first network connection will sufficiently deteriorate based upon the present location of the multi-SIM wireless device.

23. The method of claim 22, wherein predicting whether the first network connection will sufficiently deteriorate is performed by accessing a database of low-quality reception zones for the first network.

24. The method of claim 22, wherein predicting whether the first network connection will sufficiently deteriorate is performed using stored records from previous communications on the multi-SIM wireless device over the first network.

25. A multi-SIM wireless device comprising:
a display,
a memory;
a transceiver configured to interface with at least a first network associated with a first SIM;
a processor coupled to the display, the memory, and the transceiver, wherein the processor is configured to perform operations comprising:
establishing a first active call with a third party device on the first network associated with the first SIM;
determining whether the first active call should be transferred to a second network associated with a second SIM;
establishing, via the first network associated with the first SIM, a multi-party conference call with the second network associated with the second SIM and the third party device in response to determining that the first active call should be transferred to the second network; and
releasing the first active call so that the multi-party conference call becomes a new active call between with the third party device via the second network associated with the second SIM.

26. The multi-SIM wireless device of claim 25, wherein the processor is configured to perform operations such that establishing the multi-party conference call comprises:
triggering the second network associated with the second SIM to send a paging signal to the first SIM;
placing the first active call on hold;
responding to the paging signal from the second network associated with the second SIM, thereby establishing a second active call; and
removing the first active call from hold.

27. The multi-SIM wireless device of claim 26, wherein the processor is configured to perform operations such that determining whether the first active call should be transferred to the second network comprises:
monitoring radio channel conditions of a first network connection; and
determining whether the first network connection has sufficiently deteriorated based on the radio channel conditions of the first network connection.

28. The multi-SIM wireless device of claim of claim 27, wherein the processor is configured to perform operations such that monitoring radio channel conditions of the first network connection comprises:
monitoring received signal strength for a radio channel of a camped-on cell of the first network; and
calculating a received signal strength indicator (RSSI) value for the camped-on cell of the first network.

29. The multi-SIM wireless device of claim 28, wherein the processor is configured to perform operations such that determining whether the first network connection has sufficiently deteriorated comprises comparing the calculated RSSI value for the camped-on cell of the first network to a call failure threshold.

30. The multi-SIM wireless device of claim 29, wherein the processor is configured to perform operations further comprising:
determining whether the calculated RSSI value for the cell of the first network is below the call failure threshold.

31. The multi-SIM wireless device of claim 30, wherein the processor is configured to perform operations such that triggering the second network associated with the second SIM to send the paging signal to the first SIM comprises:
starting a timer in response to determining that the calculated RSSI value is below a trigger threshold; and
determining whether the timer has expired, wherein the triggering the second network associated with the second SIM is performed upon expiration of the timer.

32. The multi-SIM wireless device of claim 31, wherein the processor is configured to perform operations further comprising:
determining whether the timer is running and cancelling the timer in response to determining that the calculated RSSI value for the cell of the first network is not below the trigger threshold.

33. The multi-SIM wireless device of claim 31, wherein the trigger threshold is equal to the call failure threshold.

34. The multi-SIM wireless device of claim 31, wherein the trigger threshold is independent of the call failure threshold.

35. The multi-SIM wireless device of claim 31, wherein a duration of the timer is preset in response to a received user input.

36. The multi-SIM wireless device of claim 29, wherein the call failure threshold is determined based upon a received user input.

37. The multi-SIM wireless device of claim 29, wherein the processor is configured to perform operations such that determining whether the first network connection has sufficiently deteriorated further comprises:
monitoring received signal strength for a camped-on cell of the second network;
calculating a RSSI value for a radio channel of the camped-on cell of the second network; and
comparing the calculated RSSI values for the camped-on cells of the first and second networks.

38. The multi-SIM wireless device of claim 37, wherein the processor is configured to perform operations such that determining whether the first active call will be transferred to the second network further comprises determining whether the second SIM is idle.

39. The multi-SIM wireless device of claim 25, wherein the processor is configured to perform operations such that determining whether the first active call will be transferred to the second network comprises:
determining whether a sufficient signal is received b from one or more neighboring cells in the first network,
wherein the first active call is maintained on the first network and handed off to a neighboring cell in response to determining that a sufficient signal is received from one or more neighboring cells in the first network.

40. The multi-SIM wireless device of claim 27, wherein the processor is configured to perform operations such that monitoring radio channel conditions of the first network connection comprises:
monitoring a carrier-to-noise ratio of a received radio signal of the first network.

41. The multi-SIM wireless device of claim 25, wherein the processor is configured to perform operations such that releasing the first active call comprises:
sending a message containing an Explicit Call Transfer (ECT) supplementary services request to a component of the first network.

42. The multi-SIM wireless device of claim 25, wherein the multi-SIM wireless device is a dual-SIM dual active (DSDA) wireless communication device.

43. The multi-SIM wireless device of claim 25, wherein a channel access method implemented by the first network is different than a channel access method implemented by the second network.

44. The multi-SIM wireless device of claim 25, wherein the processor is configured to perform operations further comprising:
presenting, through a user interface, a selectable option to disable call transfers between the first SIM and the second SIM,
wherein the processor is configured to perform operations such that determining whether the first active call will be transferred to the second network comprises:
determining whether user input to disable call transfers between the first SIM and the second SIM has been received, wherein the first active call is maintained on the first network in response to determining that the call transfer option has been disabled.

45. The multi-SIM wireless device of claim 44, wherein the processor is configured to perform operations such that presenting, through the user interface, the selectable option to disable call transfers between the first SIM and the second SIM includes presenting a selectable option to disable call transfers for calls that satisfy a set of criteria.

46. The multi-SIM wireless device of claim 25, wherein the processor is configured to perform operations further comprising:
determining a present location of the multi-SIM wireless device; and
predicting whether a first network connection will sufficiently deteriorate based upon the present location of the multi-SIM wireless device.

47. The multi-SIM wireless device of claim 46, wherein the processor is configured to perform operations such that predicting whether the first network connection will sufficiently deteriorate is performed by accessing a database of low-quality reception zones for the first network.

48. The multi-SIM wireless device of claim 47, wherein the processor is configured to perform operations such that predicting whether the first network connection will sufficiently deteriorate is performed using stored records from previous communications on the multi-SIM wireless device over the first network.

49. A multi-SIM wireless device, comprising:
means for establishing a first active call with a third party device on a first network associated with a first SIM of the multi-SIM wireless device;
means for determining whether the first active call should be transferred to a second network associated with a second SIM of the multi-SIM wireless device;
means for establishing, via the first network associated with the first SIM, a multi-party conference call between the multi-SIM wireless device, the second network associated with the second SIM, and the third party device in response to determining that the first active call should be transferred to the second network; and
means for releasing the first active call so that the multi-party conference call becomes a new active call between the multi-SIM wireless device and the third party device via the second network associated with the second SIM.

50. The multi-SIM wireless device of claim 49, wherein means for establishing the multi-party conference call comprises:
means for triggering the second network associated with the second SIM to send a paging signal to the first SIM;
means for placing the first active call on hold;
means for responding to the paging signal from the second network associated with the second SIM, thereby establishing a second active call; and
means for removing the first active call from hold.

51. The multi-SIM wireless device of claim 50, wherein means for determining whether the first active call should be transferred to the second network comprises:
means for monitoring radio channel conditions of a first network connection in the multi-SIM wireless device; and
means for determining whether the first network connection has sufficiently deteriorated based on the radio channel conditions of the first network connection.

52. The multi-SIM wireless device of claim 51, wherein means for monitoring radio channel conditions of the first network connection comprises:
means for monitoring received signal strength for a radio channel of a camped-on cell of the first network; and
means for calculating a received signal strength indicator (RSSI) value for the camped-on cell of the first network.

53. The multi-SIM wireless device of claim 52, wherein means for determining whether the first network connection has sufficiently deteriorated comprises means for comparing the calculated RSSI value for the camped-on cell of the first network to a call failure threshold.

54. The multi-SIM wireless device of claim 53, further comprising:
means for determining whether the calculated RSSI value for the cell of the first network is below the call failure threshold.

55. The multi-SIM wireless device of claim 54, wherein means for triggering the second network associated with the second SIM to send the paging signal to the first SIM comprises:
means for starting a timer in response to determining that the calculated RSSI value is below a trigger threshold; and
means for determining whether the timer has expired, wherein the triggering the second network associated with the second SIM is performed upon expiration of the timer.

56. The multi-SIM wireless device of claim 55, further comprising:
means for determining whether the timer is running and cancelling the timer in response to determining that the calculated RSSI value for the cell of the first network is not below the trigger threshold.

57. The multi-SIM wireless device of claim 56, wherein the trigger threshold is equal to the call failure threshold.

58. The multi-SIM wireless device of claim 56, wherein the trigger threshold is independent of the call failure threshold.

59. The multi-SIM wireless device of claim 55, wherein a duration of the timer is preset in response to a user input received by the multi-SIM wireless device.

60. The multi-SIM wireless device of claim 55, wherein the call failure threshold is determined based upon user input received by the multi-SIM wireless device.

61. The multi-SIM wireless device of claim 53, wherein means for determining whether the first network connection has sufficiently deteriorated further comprises:
means for monitoring received signal strength for a camped-on cell of the second network;
means for calculating a RSSI value for a radio channel of the camped-on cell of the second network; and
means for comparing the calculated RSSI values for the camped-on cells of the first and second networks.

62. The multi-SIM wireless device of claim 61, wherein means for determining whether the first active call will be transferred to the second network further comprises means for determining whether the second SIM is idle.

63. The multi-SIM wireless device of claim 49, wherein means for determining whether the first active call will be transferred to the second network comprises:
means for determining whether a sufficient signal is received by the multi-SIM wireless device from one or more neighboring cells in the first network,
means for wherein the first active call is maintained on the first network and handed off to a neighboring cell in response to determining that a sufficient signal is received by the multi-SIM wireless device from one or more neighboring cells in the first network.

64. The multi-SIM wireless device of claim 51, wherein means for monitoring radio channel conditions of the first network connection comprises
means for monitoring a carrier-to-noise ratio of a received radio signal of the first network.

65. The multi-SIM wireless device of claim 49, wherein releasing the first active call comprises:
means for sending a message containing an Explicit Call Transfer (ECT) supplementary services request to a component of the first network.

66. The multi-SIM wireless device of claim 49, wherein the multi-SIM wireless device is a dual-SIM dual active (DSDA) wireless communication device.

67. The multi-SIM wireless device of claim 49, wherein means for channel access implemented by the first network is different than means for channel access implemented by the second network.

68. The multi-SIM wireless device of claim 49, further comprising:
means for presenting, through a user interface, a selectable option to disable call transfers between the first SIM and the second SIM,
wherein means for determining whether the first active call will be transferred to the second network comprises:
means for determining whether user input to disable call transfers between the first SIM and the second SIM has been received, wherein the first active call is maintained on the first network in response to determining that the call transfer option has been disabled.

69. The multi-SIM wireless device of claim 68, wherein means for presenting, through the user interface, the selectable option to disable call transfers between the first SIM and the second SIM includes means for presenting a selectable option to disable call transfers for calls that satisfy a set of criteria.

70. The multi-SIM wireless device of claim 49, further comprising:
means for determining a present location of the multi-SIM wireless device; and
means for predicting whether a first network connection will sufficiently deteriorate based upon the present location of the multi-SIM wireless device.

71. The multi-SIM wireless device of claim 70, wherein means for predicting whether the first network connection will sufficiently deteriorate comprises means for accessing a database of low-quality reception zones for the first network.

72. The multi-SIM wireless device of claim 70, wherein means for predicting whether the first network connection will sufficiently deteriorate comprises means for using stored records from previous communications on the multi-SIM wireless device over the first network.

73. A non-transitory processor-readable storage medium having stored thereon processor-executable instructions configured to cause a multi-SIM wireless device processor to perform operations comprising:
establishing a first active call with a third party device on a first network associated with a first SIM;
determining whether the first active call should be transferred to a second network associated with a second SIM;
establishing, via the first network associated with the first SIM, a multi-party conference call with the second network associated with the second SIM and the third party device in response to determining that the first active call should be transferred to the second network; and
releasing the first active call so that the multi-party conference call becomes a new active call with the third party device via the second network associated with the second SIM.

74. The non-transitory processor-readable storage medium of claim 73, wherein the stored processor-executable instructions are configured to cause the multi-SIM wireless device processor to perform operations further comprising:
triggering the second network associated with the second SIM to send a paging signal to the first SIM;
placing the first active call on hold;
responding to the paging signal from the second network associated with the second SIM, thereby establishing a second active call; and
removing the first active call from hold.

75. The non-transitory processor-readable storage medium of claim 74, wherein the stored processor-executable instructions are configured to cause the multi-SIM wireless device processor to perform operations such that determining whether the first active call should be transferred to the second network comprises:
monitoring radio channel conditions of a first network connection in the multi-SIM wireless device; and
determining whether the first network connection has sufficiently deteriorated based on the radio channel conditions of the first network connection.

76. The non-transitory processor-readable storage medium of claim 75, wherein the stored processor-executable instructions are configured to cause the multi-SIM wireless device processor to perform operations such that monitoring radio channel conditions of the first network connection comprises:
monitoring received signal strength for a radio channel of a camped-on cell of the first network; and
calculating a received signal strength indicator (RSSI) value for the camped-on cell of the first network.

77. The non-transitory processor-readable storage medium of claim 76, wherein the stored processor-executable instructions are configured to cause the multi-SIM wireless device processor to perform operations such that determining whether the first network connection has sufficiently deteriorated comprises comparing the calculated RSSI value for the camped-on cell of the first network to a call failure threshold.

78. The non-transitory processor-readable storage medium of claim 77, wherein the stored processor-executable instructions are configured to cause the multi-SIM wireless device processor to perform operations further comprising:
determining whether the calculated RSSI value for the cell of the first network is below the call failure threshold.

79. The non-transitory processor-readable storage medium of claim 78, wherein the stored processor-executable instructions are configured to cause the multi-SIM wireless device processor to perform operations such that triggering the second network associated with the second SIM to send the paging signal to the first SIM comprises:
starting a timer in response to determining that the calculated RSSI value is below a trigger threshold; and
determining whether the timer has expired, wherein the triggering the second network associated with the second SIM is performed upon expiration of the timer.

80. The non-transitory processor-readable storage medium of claim 79, wherein the stored processor-executable instructions are configured to cause the multi-SIM wireless device processor to perform operations further comprising:
determining whether the timer is running and cancelling the timer in response to determining that the calculated RSSI value for the cell of the first network is not below the trigger threshold.

81. The non-transitory processor-readable storage medium of claim 80, wherein the stored processor-executable instructions are configured to cause the multi-SIM wireless device processor to perform operations such that the trigger threshold is equal to the call failure threshold.

82. The non-transitory processor-readable storage medium of claim 80, wherein the stored processor-executable instructions are configured to cause the multi-SIM wireless device processor to perform operations such that the trigger threshold is independent of the call failure threshold.

83. The non-transitory processor-readable storage medium of claim 79, wherein the stored processor-executable instructions are configured to cause the multi-SIM wireless device processor to perform operations such that a duration of the timer is preset in response to a user input received by the multi-SIM wireless device.

84. The non-transitory processor-readable storage medium of claim 77, wherein the stored processor-executable instructions are configured to cause the multi-SIM wireless device processor to perform operations such that the call failure threshold is determined based upon a user input received by the multi-SIM wireless device.

85. The non-transitory processor-readable storage medium of claim 77, wherein the stored processor-executable instructions are configured to cause the multi-SIM wireless device processor to perform operations such that determining whether the first network connection has sufficiently deteriorated further comprises:
monitoring received signal strength for a camped-on cell of the second network;
calculating a RSSI value for a radio channel of the camped-on cell of the second network; and
comparing the calculated RSSI values for the camped-on cells of the first and second networks.

86. The non-transitory processor-readable storage medium of claim 85, wherein the stored processor-executable instructions are configured to cause the multi-SIM wireless device processor to perform operations such that determining whether the first active call will be transferred to the second network further comprises determining whether the second SIM is idle.

87. The non-transitory processor-readable storage medium of claim 73, wherein the stored processor-executable instructions are configured to cause the multi-SIM wireless device processor to perform operations such that determining whether the first active call will be transferred to the second network comprises:
determining whether a sufficient signal is received by the multi-SIM wireless device from one or more neighboring cells in the first network,
wherein the stored processor-executable instructions are configured to cause the multi-SIM wireless device processor to perform operations such that the first active call is maintained on the first network and handed off to a neighboring cell in response to determining that a sufficient signal is received by the multi-SIM wireless device from one or more neighboring cells in the first network.

88. The non-transitory processor-readable storage medium of claim 75, wherein the stored processor-executable instructions are configured to cause the multi-SIM wireless device processor to perform operations such that monitoring radio channel conditions of the first network connection comprises:
monitoring a carrier-to-noise ratio of a received radio signal of the first network.

89. The non-transitory processor-readable storage medium of claim 73, wherein the stored processor-executable instructions are configured to cause the multi-SIM wireless device processor to perform operations such that releasing the first active call comprises:
sending a message containing an Explicit Call Transfer (ECT) supplementary services request to a component of the first network.

90. The non-transitory processor-readable storage medium of claim 73, wherein the stored processor-executable instructions are configured to be executed on a processor of a dual-SIM dual active (DSDA) wireless communication device.

91. The non-transitory processor-readable storage medium of claim 73, wherein the stored processor-executable instructions are configured to cause the multi-SIM wireless device processor to perform operations such that a channel access method implemented by the first network is different than a channel access method implemented by the second network.

92. The non-transitory processor-readable storage medium of claim 73, wherein the stored processor-executable instructions are configured to cause the multi-SIM wireless device processor to perform operations further comprising:
presenting, through a user interface, a selectable option to disable call transfers between the first SIM and the second SIM,
wherein the stored processor-executable instructions are configured to cause the multi-SIM wireless device processor to perform operations such that determining whether the first active call will be transferred to the second network comprises:
determining whether user input to disable call transfers between the first SIM and the second SIM has been received, wherein the first active call is maintained on the first network in response to determining that the call transfer option has been disabled.

93. The non-transitory processor-readable storage medium of claim 92, wherein the stored processor-executable instructions are configured to cause the multi-SIM wireless device processor to perform operations such that presenting, through the user interface, the selectable option to disable call transfers between the first SIM and the second SIM includes presenting a selectable option to disable call transfers for calls that satisfy a set of criteria.

94. The non-transitory processor-readable storage medium of claim 73, wherein the stored processor-executable instructions are configured to cause the multi-SIM wireless device processor to perform operations further comprising:
determining a present location of the multi-SIM wireless device; and
predicting whether a first network connection will sufficiently deteriorate based upon the present location of the multi-SIM wireless device.

95. The non-transitory processor-readable storage medium of claim 94, wherein the stored processor-executable instructions are configured to cause the multi-SIM wireless device processor to perform operations such that predicting whether the first network connection will sufficiently deteriorate is performed by accessing a database of low-quality reception zones for the first network.

96. The non-transitory processor-readable storage medium of claim 94, wherein the stored processor-executable instructions are configured to cause the multi-SIM wireless device processor to perform operations such that predicting whether the first network connection will sufficiently deteriorate is performed using stored records from previous communications on the multi-SIM wireless device over the first network.
